(19) United States
(12) Patent Application Publication
(10) Pub. No.: US 2015/0054998 A1
(43) Pub. Date: Feb. 26, 2015

(54) SOLID-STATE IMAGING APPARATUS

(71) Applicant: CANON KABUSHIKI KAISHA, Tokyo (JP)

(72) Inventor: Taikan Kanou, Kawasaki-shi (JP)

(21) Appl. No.: 14/454,863

(22) Filed: Aug. 8, 2014

(30) Foreign Application Priority Data
Aug. 22, 2013 (JP) 2013-172661
Jul. 24, 2014 (JP) 2014-151042

(51) Int. Cl. H04N 5/374

(52) U.S. Cl. CPC H04N 5/3742
USPC 348/308

(57) ABSTRACT

A solid-state imaging apparatus includes a plurality of pixels arranged in an array, each including a photoelectric converter and a transfer transistor, a driving circuit configured to supply a control signal to the transfer transistor of each of the plurality of pixels, and a plurality of driving lines connecting the transfer transistors of the plurality of pixels and the driving circuit. The plurality of pixels include a first pixel and a second pixel connected to the same driving line. A distance from the driving circuit to the first pixel is longer than a distance from the driving circuit to the second pixel. A driving force of the transfer transistor in the first pixel is lower than a driving force of the transfer transistor in the second pixel.

### BACKGROUND OF THE INVENTION

1. Field of the Invention

The present invention relates to a solid-state imaging apparatus.

2. Description of the Related Art

An increase in the wiring length of a solid-state imaging apparatus along with an increase in its size leads to the voltage drop or the delay of a signal flowing through the wiring. This readily causes image luminance unevenness called shading. In Japanese Patent Laid-Open No. 2007-150560, a potential is supplied from a driving buffer for each pixel column and a vertical driving circuit for each pixel row, so that an error owing to the decrease in a reset potential upon an increase in a wiring length is reduced, thereby reducing shading.

### SUMMARY OF THE INVENTION

Even in a solid-state imaging apparatus disclosed in Japanese Patent Laid-Open No. 2007-150560, a control signal which controls a transfer transistor for each pixel is supplied from a driving circuit via a driving line. Due to the influence of a delay or the like, the waveform of the control signal changes among the pixels whose distances from the driving circuit are long and short. The present inventor has found that shading may occur in an image obtained by the solid-state imaging apparatus owing to this waveform change. An aspect of the present invention provides a technique for reducing shading which occurs in the solid-state imaging apparatus.

According to a first aspect, provided is a solid-state imaging apparatus including a plurality of pixels arranged in an array, each including a photoelectric converter and a transfer transistor, a driving circuit configured to supply a control signal to the transfer transistor of each of the plurality of pixels, and a plurality of driving lines connecting the transfer transistors of the plurality of pixels and the driving circuit. The plurality of pixels include a first pixel and a second pixel connected to the same driving line. A distance from the driving circuit to the first pixel is longer than a distance from the driving circuit to the second pixel. A driving force of the transfer transistor in the first pixel is lower than a driving force of the transfer transistor in the second pixel.

According to a second aspect, provided is a solid-state imaging apparatus comprising: a plurality of pixels arranged in an array, each including a photoelectric converter and a transfer transistor; a driving circuit configured to supply a control signal to the transfer transistor of each of the plurality of pixels; and a plurality of driving lines connecting the transfer transistors of the plurality of pixels and the driving circuit, wherein the plurality of pixels include a first pixel and a second pixel connected to the same driving line, a distance from the driving circuit to the first pixel is longer than a distance from the driving circuit to the second pixel, and a gate length of a gate electrode the transfer transistor in the first pixel is longer than a gate length of a gate electrode of the transfer transistor in the second pixel.

According to a third aspect, provided is a solid-state imaging apparatus comprising: a plurality of pixels arranged in an array, each including a photoelectric converter and a transfer transistor; a driving circuit configured to supply a control signal to the transfer transistor of each of the plurality of pixels; and a plurality of driving lines connecting the transfer transistors of the plurality of pixels and the driving circuit, wherein the plurality of pixels include a first pixel and a second pixel connected to the same driving line, a distance from the driving circuit to the first pixel is longer than a distance from the driving circuit to the second pixel, and a gate width of a gate electrode the transfer transistor in the first pixel is narrower than a gate width of a gate electrode of the transfer transistor in the second pixel.

Further features of the present invention will become apparent from the following description of exemplary embodiments (with reference to the attached drawings).

### BRIEF DESCRIPTION OF THE DRAWINGS

FIGS. 1A and 1B are diagrams for explaining examples of the arrangement of a solid-state imaging apparatus according to some embodiments;

FIG. 2 is a diagram for explaining examples of a waveform change of a control signal according to some embodiments;

FIG. 3 is a plan view for explaining the gate lengths of transfer transistors according to some embodiments;

FIGS. 4A and 4B are views for explaining grouping of pixels according to some embodiments;

FIG. 5 is a view for explaining grouping of the pixels according to some embodiments;

FIG. 6 is a flowchart for explaining an example of a method of manufacturing the solid-state imaging apparatus according to some embodiments; and

FIG. 7 is a plan view for explaining the gate lengths of the transfer transistors according to some embodiments.

### DESCRIPTION OF THE EMBODIMENTS

The embodiments of the present invention will be explained below with reference to the accompanying drawings. The same reference numerals throughout various embodiments denote the same elements, and a repetitive description will be omitted. In the following description, a charge is an electron. However, the present invention is not limited to this, and it is possible to appropriately change and combine the embodiments.

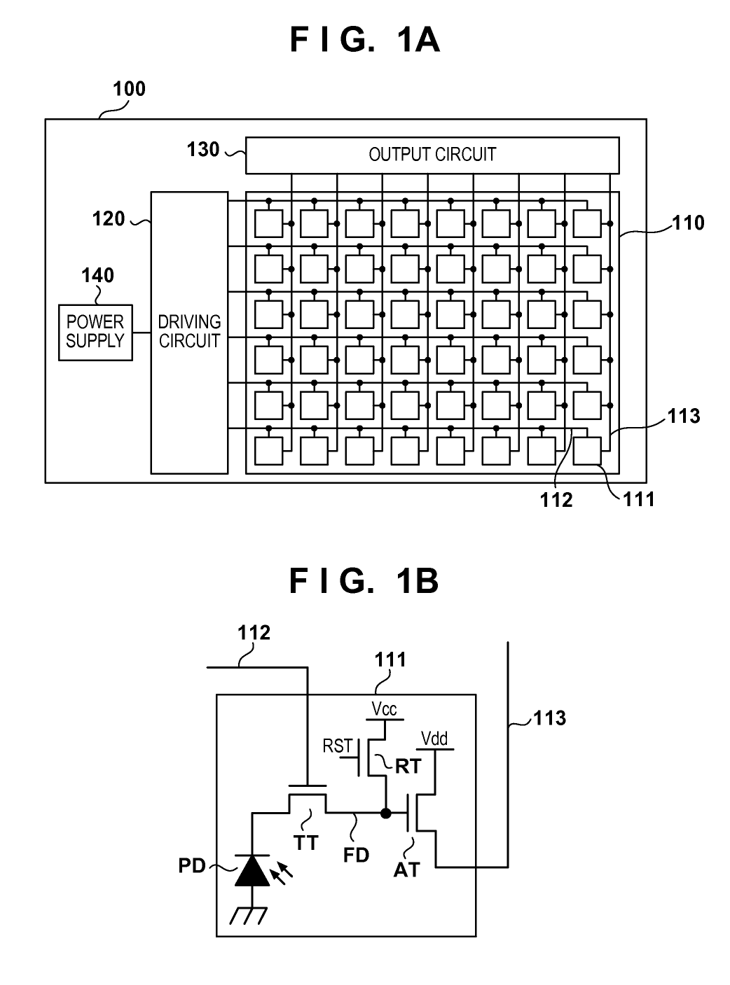

An example of the arrangement of a solid-state imaging apparatus 100 according to some embodiments will be described with reference to FIGS. 1A and 1B. FIG. 1A is a layout diagram of respective components of the entire solid-state imaging apparatus 100. The solid-state imaging apparatus 100 can include a pixel array 110, a driving circuit 120, an output circuit 130, and a power supply 140. In the pixel array 110, a plurality of pixels 111 are arranged in an array. The driving circuit 120 supplies a control signal for controlling the operation of the pixels 111 to the pixels 111 via driving lines 112. The output circuit 130 reads out pixel signals generated in the pixels 111 via signal lines 113 and outputs them outside. The power supply 140 supplies power to the driving circuit 120.

The solid-state imaging apparatus 100 includes the plurality of driving lines 112 all of which are connected to the driving circuit 120. The respective driving lines 112 extend in the row direction (the horizontal direction in FIG. 1A) and are commonly connected to the plurality of pixels 111 arranged in the row direction. Also, the solid-state imaging apparatus 100 includes the plurality of signal lines 113 all of which are connected to the output circuit 130. The respective signal lines 113 extend in the column direction (the vertical direction in FIG. 1A) and are commonly connected to the plurality of pixels 111 arranged in the column direction.

The present invention is applicable to any arrangements of the pixels 111 which include a photoelectric converter and a transfer transistor. An example of such arrangement will be described with reference to an equivalent circuit diagram of FIG. 1B. Each pixel 111 can include a photodiode PD as an example of the photoelectric converter, a transfer transistor TT, a reset transistor RT, and an amplifier transistor AT. These transistors are, for example, MOS transistors. One main electrode of the transfer transistor TT is connected to the photodiode PD, the other main electrode is connected to a floating diffusion region FD (to be referred to as the FD region FD hereinafter), and the gate is connected to the driving line 112. One main electrode of the reset transistor RT receives a reset voltage, the other main electrode is connected to the FD region FD, and the gate receives a reset signal RST. One main electrode of the amplifier transistor AT receives a power supply voltage, the other main electrode is connected to the signal line 113, and the gate is connected to the FD region FD. Light that has entered the photodiode PD is converted into a charge, and transferred to the FD region FD upon turning on the transfer transistor TT. Then, the potential in the FD region FD is amplified by the amplifier transistor AT to be read out as a pixel signal. The potential in the FD region FD is reset upon turning on the reset transistor RT. Note that each pixel 111 may also include another photodiode PD and another transfer transistor TT. Furthermore, in some cases, the reset transistor RT, the amplifier transistor AT, or the like can be shared with another pixel.

The pixel array 110 may include a pixel addition transistor. For example, the pixel addition transistor is arranged to connect the FD regions FD in the two adjacent pixels 111. The potential difference between the potential of the reset transistor RT and that of the pixel addition transistor is made larger to operate the pixel addition transistor. Accordingly, a potential applied to the FD region FD is reduced in some cases. The decrease in the potential in the FD region FD creates a situation in which shading is likely to occur.

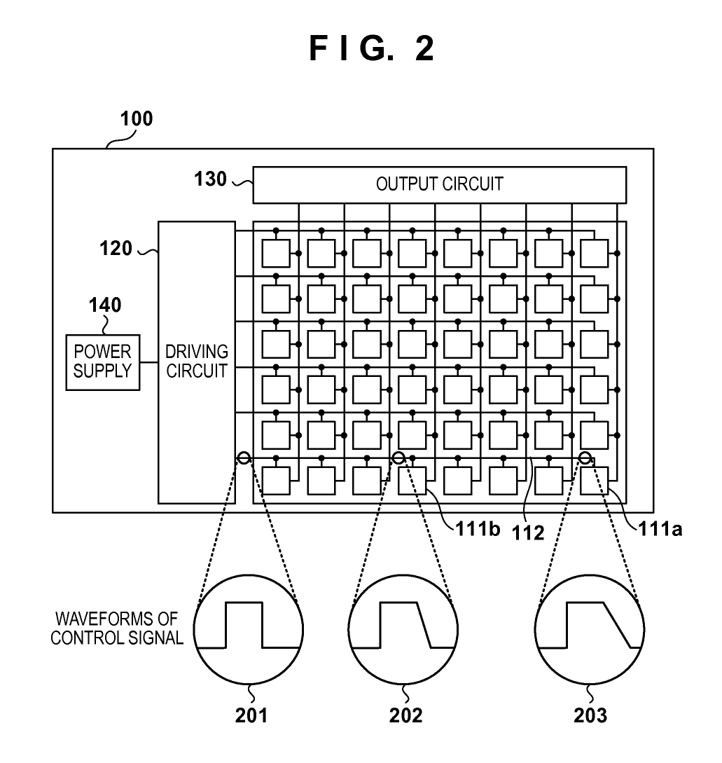

The waveforms of a control signal flowing through the driving lines 112 will now be described with reference to FIG. 2. For the waveform of the control signal flowing through a position 201 which is close to the driving circuit 120 of the driving line 112, a voltage falls vertically. For the waveform of the control signal flowing through a position 202 which is in the middle of the driving line 112, the voltage falls moderately due to the influence of an IR drop. For the waveform of the control signal flowing through a position 203 which is far from the driving circuit 120 of the driving line 112, the voltage falls more moderately. In this way, the farther the control signal flowing through the driving line 112 away from the driving circuit 120, the more moderate the fall of the voltage. As a result, the amount of electrons which exist in the FD region FD varies among the pixels 111 after the transfer transistor TT transits from the on state to the off state. Owing to this variation in the electron amount, shading occurs in an image obtained by the solid-state imaging apparatus 100.

The present inventor has found that this variation is caused by the change in the amount of electrons into the FD region FD positioned at a channel between the photodiode PD and the FD region FD in accordance with the fall of a voltage when the transfer transistor TT transits from the on state to the off state. In addition, the present inventor has found that this electron amount also depends on the driving force of the transfer transistor TT. The driving force of the transfer transistor TT represents the capacity of a current amount that the transfer transistor TT can flow the current per unit time. The driving force of the transfer transistor TT depends on the size of a portion covering the channel region of a gate GT of the transfer transistor TT. The length of the portion covering the channel region of the gate GT of the transfer transistor TT in the channel length direction is referred to as a gate length of a gate electrode of the transfer transistor TT. The shorter the gate length, the more the current amount flows per unit time, resulting in the increase in the driving force of the transfer transistor TT. Furthermore, the length of the portion covering the channel region of the gate GT of the transfer transistor TT in the channel width direction is referred to as a gate width of a gate electrode of the transfer transistor TT. The wider the gate width, the more the current amount flows per unit time, resulting in the increase in the driving force of the transfer transistor TT. Note that the channel region is a region in which an element isolation is not provided in a planar view and in which an active region surrounded by the element isolation and a gate electrode is provided.

In some embodiments, shading owing to the waveform change of the control signal is reduced by adjusting the gate length of the transfer transistor TT in the pixel 111. To be more specific, the farther the transfer transistor TT in the pixel 111 away from the driving circuit 120, the lower its driving force. The distance from the driving circuit 120 to the pixel 111 may be defined by a linear distance or the length of a portion of the driving line 112 connecting the driving circuit 120 and the pixel 111. This arrangement makes it possible to reduce shading which occurs depending on the distance from the driving circuit.

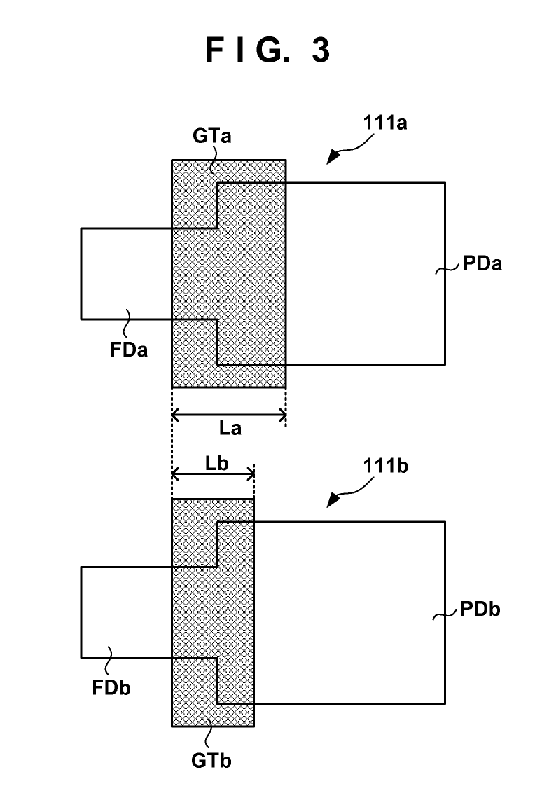

According to some embodiments, the arrangements of the transfer transistors TT in two pixels whose distances from the driving circuit 120 are different will be described with reference to FIG. 3. In FIG. 3, the driving force of the transfer transistor TT is adjusted by adjusting the gate length of the transfer transistor TT. The schematic plan view in the upper side of FIG. 3 pays attention to a part of a pixel 111a (FIG. 2) with a long distance from the driving circuit 120 and shows a photodiode PDa, an FD region FDa, and a gate GTa of the transfer transistor. The schematic plan view in the lower side of FIG. 3 pays attention to a part of a pixel 111b (FIG. 2) with a medium distance from the driving circuit 120 and shows a photodiode PDb, an FD region FDb, and a gate GTb of the transfer transistor. As shown in FIG. 3, a gate length La of the gate GTa of the transfer transistor in the pixel 111a is longer than a gate length Lb of the gate GTb of the transfer transistor in the pixel 111b. In an example of FIG. 3, the edge positions of the gates GTa and GTb are the same on the side of FD regions FDa and FDb, but different on the side of photodiodes PDa and PDb. The shape of a region in which a channel is formed may be different from that in the example of FIG. 3 as long as the gate length can be adjusted.

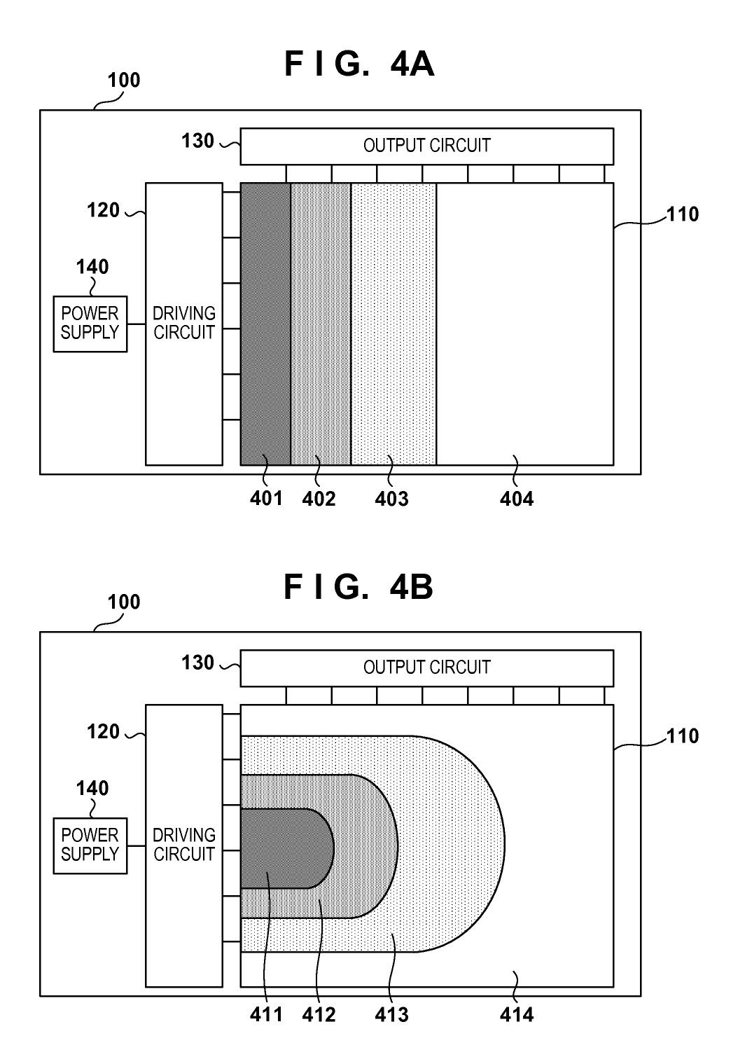

The plurality of pixels 111 included in the pixel array 110 may have individual gate lengths based on the distances from the driving circuit 120 to the respective pixels. Instead of this, the plurality of pixels 111 included in the pixel array 110 may be divided into a plurality of groups based on the distances from the driving circuit 120 to the respective pixels and have different gate lengths for the respective groups. In an example of FIG. 4A, the pixel array 110 is divided into four rectangular regions 401, 402, 403, and 404 in accordance with the distances from the driving circuit 120, and the pixels included in the respective regions 401 to 404 form the groups. The region 401 is positioned closest to the driving circuit 120, and the regions 402, 403, and 404 are positioned farther away from the driving circuit 120 in the order named. Consequently, the transfer transistor TT in the pixel 111 included in the region 401 has the shortest gate length, and the transfer transistors TT in the pixels 111 included in the regions 402, 403, and 404 have longer gate lengths in the order named. The transfer transistors TT in the plurality of pixels 111 included in the same region may all have the same gate length. The gate length may differ at intervals of 0.02 μm between the adjacent regions. For example, the gate length in the pixel included in the region 401 and that in the pixel included in the region 402 may differ by 0.02 μm.

In some embodiments, the number of pixel groups is smaller than the number of pixels (that is, the number of pixel columns) connected to the same driving line. In this case, two or more pixels 111 connected to the same driving line belong to the same group, thus having the same gate length. In another embodiment, the pixel group may be formed for each pixel column. In this case, the pixels connected to the same driving line 112 belong to different groups, thus having different gate lengths.

In the example of FIG. 4A, the pixel array 110 is divided into the rectangular regions. However, other shapes may be used for division. The waveform change of the control signal flowing through the driving line 112 depends not only on the distance between the driving circuit 120 and the pixel 111 but also on the distance between the power supply 140 and the driving line 112, in some cases. For example, the control signal flowing through the driving line 112 with the long distance from the power supply 140 has greater waveform change (rounding of the waveform). In an example of FIG. 4B, even when two or more pixels 111 are at the equal distance from the driving circuit 120 (that is, the pixels 111 belonging to the same pixel column), the pixel 111 which is connected to the driving line 112 positioned far from the power supply 140 has longer gate length of the transistor TT. Hence, the transfer transistor TT in the pixel 111 included in a region 411 has the shortest gate length, and the transfer transistors TT in the pixels 111 included in regions 412, 413, and 414 have longer gate lengths in the order named. As in the example of FIG. 4A, the gate length may differ at intervals of 0.02 μm between the regions. The pixel array 110 is divided into four regions in the examples of FIGS. 4A and 4B. However, the pixel array 110 may be divided into any number of regions if it is two or more.

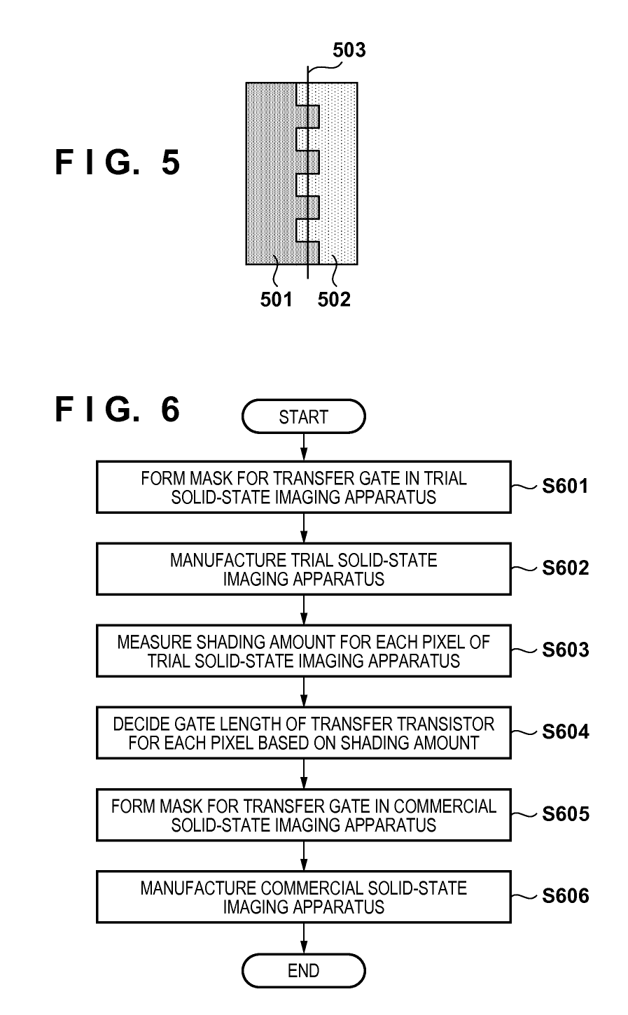

The pixel group arrangement according to some embodiments will be described with reference to FIG. 5. FIG. 5 is an enlarged view showing a portion near the boundary between two regions 501 and 502 adjacent to each other. As in FIG. 4A, if the boundary between the adjacent regions is linear, this boundary portion may be noticeable in an image obtained by the solid-state imaging apparatus 100. To prevent this, in an example of FIG. 5, the pixels 111 are arranged in a comblike manner at the boundary between the regions 501 and 502, interdigitating the regions 501 and 502. Therefore, as for the plurality of pixels (pixels on a straight line 503 in FIG. 5) at the equal distance from the driving circuit 120, the pixel included in the region 501 and the pixel included in the region 502 appear alternately per one or more pixels. This enables the region boundary to be less noticeable in the image obtained by the solid-state imaging apparatus 100. The boundary between the regions 501 and 502 may have not only an orthogonal shape as shown in FIG. 5 but also a wavy shape, or even have other shapes. Furthermore, when the pixel array 110 has a plurality of region boundaries, either some or all of the boundaries may have the shape as shown in FIG. 5.

A method of manufacturing the solid-state imaging apparatus 100 will now be described with reference to FIG. 6. A trial mask for forming a transfer transistor gate in a trial solid-state imaging apparatus is formed in step S601. In this mask, for example, all pixels have the same gate length. Then, the trial solid-state imaging apparatus is manufactured in step S602. The transfer transistor gate of the trial solid-state imaging apparatus is manufactured using the trial mask formed in step S601. The trial solid-state imaging apparatus may be manufactured by any methods such as a known method as long as it can create a pixel including a photoelectric converter and a transfer transistor. Therefore, a description will be omitted.

Then, a shading amount which occurs in each pixel of the trial solid-state imaging apparatus is measured in step S603. The shading amount refers to an amount representing the degree of shading which occurs in the pixel, and is decided based on a pixel signal of each pixel obtained by, for example, irradiating the trial solid-state imaging apparatus with uniform light.

Then, the gate length of the transfer transistor in each pixel of a commercial solid-state imaging apparatus is decided based on the shading amount in step S604. The gate length may be decided for each pixel or pixel group. The ratio of the shading amount to the gate length may be set to, for example, a one-to-one correspondence. Instead of this, the shading amount is divided into a plurality of ranges, and the pixels included in each range are set to have the same gate length. For example, the pixel whose shading amount is 15 or more belongs to the first group, and the same gate length is set for the pixels in the first group. The pixel in the first group can be the pixel positioned, for example, in the region 401 of FIG. 4A. Further, the pixel whose shading amount is 10 (inclusive) to 15 (exclusive) belongs to the second group. The pixel in the second group can be the pixel positioned, for example, in the region 402 of FIG. 4A. Still further, the pixel whose shading amount is 5 (inclusive) to 10 (exclusive) belongs to the third group. The pixel in the third group can be the pixel positioned, for example, in the region 403 of FIG. 4A. Finally, the pixel whose shading amount is 0 (inclusive) to 5 (exclusive) belongs to the fourth group. The pixel in the fourth group can be the pixel positioned, for example, in the region 404 of FIG. 4A.

Then, a commercial mask for forming a transfer transistor gate in the commercial solid-state imaging apparatus is formed in step S605. The commercial mask is manufactured in accordance with the gate length of the transfer transistor decided in step S604. Then, the commercial solid-state imaging apparatus is manufactured in step S606. The transfer transistor gate of the commercial solid-state imaging apparatus is manufactured using the commercial mask formed in step S605. The commercial solid-state imaging apparatus may be manufactured by any methods such as a known method as long as it can create a pixel including a photoelectric converter and a transfer transistor. Therefore, a description will be omitted. By using the method described above, a solid-state imaging apparatus, such as the aforementioned solid-state imaging apparatus 100, capable of suppressing shading occurrence is manufactured.

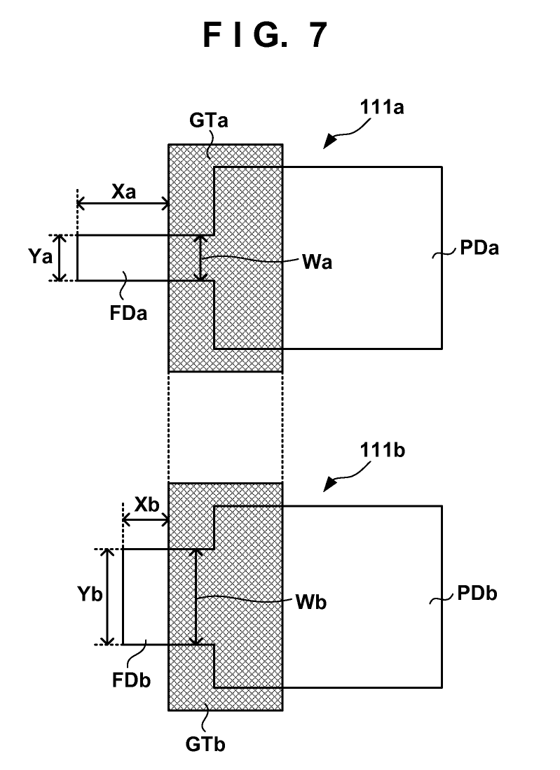

In contrast to the embodiment in FIG. 3, the arrangements of the transfer transistors TT in two pixels whose distances from the driving circuit 120 are different will now be described with reference to FIG. 7. In FIG. 7, the driving force of the transfer transistor TT is adjusted by adjusting the gate width of the transfer transistor TT. As in FIG. 3, FIG. 7 pays attention to a part of the pixel 111a (FIG. 2) with a long distance from the driving circuit 120 in the upper view, and a part of the pixel 111b (FIG. 2) with a medium distance from the driving circuit 120 in the lower view.

As shown in FIG. 7, a gate width Wa of the gate Gta of the transfer transistor TT in the pixel 111a is narrower than a gate width Wb of the gate GTb of the transfer transistor TT in the pixel 111b. In an example of FIG. 7, the gate width Wa and a width Ya of the FD region FDa are equal in the pixel 111a, and the gate width Wb and a width Yb of the FD region FDb are equal in the pixel 111b. Therefore, the pixels are formed so that a length Xa of the FD region FDa is longer than a length Xb of the FD region FDb so as to equalize the area of the FD region FDa with that of the FD region FDb. This makes capacitances in the FD region almost equal. When the gate width of the transfer transistor TT and the width of the FD region are determined to be different, the lengths of the FD regions may be equal in the pixels 111a and 111b.

The modification and the manufacturing method which have been described with reference to FIGS. 4A and 4B to 6 for the arrangement in FIG. 3 are also applicable to the arrangement in FIG. 7 by replacing the gate lengths with the gate widths. In the example of FIGS. 4A and 4B, for example, the gate lengths of the transfer transistors belonging to the adjacent groups change in units of 0.02 μm. Instead of this, the gate widths may change in the units of 0.05 μm.

Although the gate length and/or gate width is changed to change the driving force in the solid-state imaging apparatus according to the embodiments described above, other techniques can be employed to change the driving force.

As an application of the solid-state imaging apparatus according to the respective embodiments, a camera in which the solid-state imaging apparatus is assembled will be exemplarily explained. The concept of the camera includes not only an apparatus mainly aiming at image capturing but also an apparatus (for example, a personal computer or portable terminal) accessorily having an image capturing function. The camera includes the solid-state imaging apparatus according to the present invention exemplified as the embodiments, and a signal processing unit which processes a signal output from the solid-state imaging apparatus. The signal processing unit can include, for example, an A/D converter and a processor which processes digital data output from the A/D converter.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application Nos. 2013-172661, filed Aug. 22, 2013, and 2014-151042, filed Jul. 24, 2014 which are hereby incorporated by reference herein in their entirety.

What is claimed is:

1. A solid-state imaging apparatus comprising:
a plurality of pixels arranged in an array, each including a photoelectric converter and a transfer transistor;
a driving circuit configured to supply a control signal to the transfer transistor of each of the plurality of pixels; and
a plurality of driving lines connecting the transfer transistors of the plurality of pixels and the driving circuit,
wherein the plurality of pixels include a first pixel and a second pixel connected to the same driving line,
a distance from the driving circuit to the first pixel is longer than a distance from the driving circuit to the second pixel, and
a driving force of the transfer transistor in the first pixel is lower than a driving force of the transfer transistor in the second pixel.

2. The apparatus according to claim 1, wherein a gate length of the transfer transistor of the first pixel is longer than a gate length of the transfer transistor of the second pixel.

3. The apparatus according to claim 1, wherein a gate width of the transfer transistor of the first pixel is narrower than a gate width of the transfer transistor of the second pixel.

4. The apparatus according to claim 1, wherein the plurality of pixels are divided into a plurality of groups based on a distance from the driving circuit to each pixel,
driving forces of the transfer transistors in the pixels belonging to the same group are equal,
driving forces of the transfer transistors in the pixels belonging to different groups are different, and
the longer a distance from the driving circuit to a certain group is, the lower a driving force of the transfer transistor of a pixel included in the certain group is.

5. The apparatus according to claim 4, wherein the pixels connected to the same driving line belong to different groups.

6. The apparatus according to claim 4, wherein at least one of the plurality of groups includes two or more pixels connected to the same driving line.

7. The apparatus according to claim 1, further comprising a power supply configured to supply power to the driving circuit,
wherein the plurality of pixels include a third pixel and a fourth pixel which are connected to different driving lines and at an equal distance from the driving circuit,
a distance from the power supply to a driving line to which the third pixel is connected is longer than a distance from the power supply to a driving line to which the fourth pixel is connected, and
a driving force of the transfer transistor in the third pixel is lower than a driving force of the transfer transistor in the fourth pixel.

8. The apparatus according to claim 7, wherein the plurality of pixels are divided into a plurality of groups based on a distance from the driving circuit to each pixel and a distance from the power supply to a driving line to which the each pixel is connected,
driving forces of the transfer transistors in the pixels belonging to the same group are equal,
driving forces of the transfer transistors in the pixels belonging to the different groups are different, and
the longer a distance from the driving circuit to a certain group and a distance from the power supply to a driving line to which a pixel included in the certain group is connected is, the lower a driving force of the transfer transistor of a pixel included in the certain group is.

9. The apparatus according to claim 8, wherein the plurality of pixels includes two or more pixels which are at an equal distance from the driving circuit and whose driving forces of the transfer transistors are different from each other.

10. The apparatus according to claim 4, wherein the plurality of groups include a first group and a second group adjacent to the first group, and
a boundary between the first group and the second group is uneven.

11. A camera comprising:
a solid-state imaging apparatus defined in claim 1; and
a signal processing unit configured to process a signal obtained by the solid-state imaging apparatus.

12. A solid-state imaging apparatus comprising:
a plurality of pixels arranged in an array, each including a photoelectric converter and a transfer transistor;
a driving circuit configured to supply a control signal to the transfer transistor of each of the plurality of pixels; and
a plurality of driving lines connecting the transfer transistors of the plurality of pixels and the driving circuit,
wherein the plurality of pixels include a first pixel and a second pixel connected to the same driving line,
a distance from the driving circuit to the first pixel is longer than a distance from the driving circuit to the second pixel, and
a gate length of a gate electrode the transfer transistor in the first pixel is longer than a gate length of a gate electrode of the transfer transistor in the second pixel.

13. A camera comprising:
a solid-state imaging apparatus defined in claim 12; and
a signal processing unit configured to process a signal obtained by the solid-state imaging apparatus.

14. A solid-state imaging apparatus comprising:
a plurality of pixels arranged in an array, each including a photoelectric converter and a transfer transistor;
a driving circuit configured to supply a control signal to the transfer transistor of each of the plurality of pixels; and
a plurality of driving lines connecting the transfer transistors of the plurality of pixels and the driving circuit,
wherein the plurality of pixels include a first pixel and a second pixel connected to the same driving line,
a distance from the driving circuit to the first pixel is longer than a distance from the driving circuit to the second pixel, and
a gate width of a gate electrode the transfer transistor in the first pixel is narrower than a gate width of a gate electrode of the transfer transistor in the second pixel.

15. A camera comprising:
a solid-state imaging apparatus defined in claim 14; and
a signal processing unit configured to process a signal obtained by the solid-state imaging apparatus.
